(19) United States
(12) Patent Application Publication
(10) Pub. No.: US 2006/0259683 A1
(43) Pub. Date: Nov. 16, 2006

(54) Method and system for disk stippling

(75) Inventor: William Havinden Bridge JR., Alameda, CA (US)

Correspondence Address: BINGHAM, MCCUTCHEN LLP, THREE EMBARCADERO CENTER, 18 FLOOR, SAN FRANCISCO, CA, 94111-4067, US

(73) Assignee: ORACLE INTERNATIONAL CORPORATION, REDWOOD SHORES, CA (US)

(21) Appl. No.: 11/131,107

(22) Filed: May 16, 2005

(51) Int. Cl. G06F 13/28; G06F 12/00

(52) U.S. Cl. 711/112; 711/173

(57) ABSTRACT

A method, system, and program for allocating disk space and performance is disclosed. Stipples are interleaved throughout a disk to share space and performance characteristics.

### BACKGROUND AND SUMMARY

This specification is directed to computer systems and more specifically to disk space partitioning.

Conventional disk space allocation involves partitioning. Traditionally, a storage array will divide all its disks into partitions and then combine partitions from one or more disks to construct virtual disks (e.g., Logical Unit Numbers or LUNs). The partitions may be combined via striping, concatenation, mirroring, or a combination of these mechanisms. These methods have at least two disadvantages.

First, performance across a disk is not uniform. That is, blocks or partitions near the outer rim of a disk perform significantly better than those nearer the center of the disk. This is due to the speed at which the outer rim rotates in relation to the inner rim of the disk. This performance difference is commonly ignored because it is complicated to take into consideration. Software on the host does not know where its allocated space (e.g., virtual disk) is located on the physical disk, and it cannot assume that higher disk addresses are closer to the center of the disk (e.g. if there are several partitions on a disk). Thus this performance difference is not well exploited.

Second, a file system will usually consume the lower disk addresses first leaving the free space at higher addresses. This works well if the file system is using the whole physical disk. However if there are several partitions on a physical disk assigned to different hosts, then the allocated locations are separated by gaps of unused space. This results in larger seeks as the I/O is serviced for the different partitions.

Assigning whole physical disks to hosts is frequently impractical because it is too large a lump of storage. Thus partitioning disks becomes necessary, but causes the above problems. A new method of disk space partitioning is needed to solve the problems discussed above.

Embodiments herein describe stippling, a method of dividing disk space that manages disk space and performance. In one embodiment stippling may include setting stippling parameters, and configuring stipples. In another embodiment, stippling may include dividing a disk into equal portion spaces, grouping the equal portion spaces into equal size sets and allocating a portion of each set to each of a plurality of stipples. In yet another embodiment a method of managing disk performance may include interleaving stipples.

### BRIEF DESCRIPTION OF DRAWINGS

FIG. 1A illustrates process 125, one embodiment of a method of stippling a disk. FIG. 1B illustrates process 100, an embodiment of a method of stippling a disk. FIG. 2A illustrates an embodiment of process 250 which sets stipple parameters.

FIG. 2B illustrates example stipples of variable stroke sizes and stroke set sizes.

FIG. 3A illustrates example stipple bit masks and stipple member arrays.

FIG. 3B illustrates an embodiment of process 350 which configures stipples.

FIG. 4A is a physical representation of a stipple block being converted to a disk block.

FIG. 4B illustrates stipples with the corresponding stroke sets, stroke set members, and strokes.

FIG. 4C illustrates an embodiment of process 400 which converts a stipple block to a disk block.

### DETAILED DESCRIPTION

Traditionally storage (e.g., disk) is divided into a relatively small number of contiguous partitions. Stippled storage is divided into a relatively small number of interleaved portions referred to herein as stipples. Each stipple is made of a plurality of relatively small and interleaved portions spread across the storage or disk.

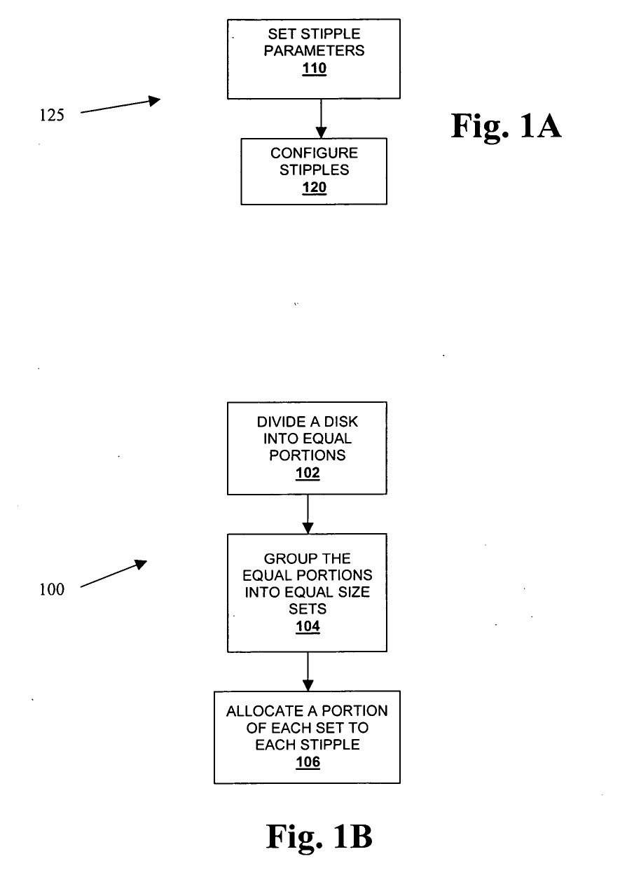

One embodiment of a method of stippling a disk is represented in process 125 of FIG. 1A. This embodiment involves determining stipple parameters 110 such as stroke size and stroke set size, and configuring stipples 120 by choosing which stroke set members will belong to which stipples. In some embodiments a stipple mask is set for each stipple based on which stroke set members are included in each stipple. In another embodiment the stipple information, including stipple masks and parameters, is stored.

Another embodiment of a method of stippling a disk is represented in process 100 of FIG. 1B. Stippling, in this embodiment, involves dividing up the disk into small equal size portions 102, grouping the portions into small equal size sets 104, and allocating a portion of each set to each stipple 106.

Sizing and Grouping

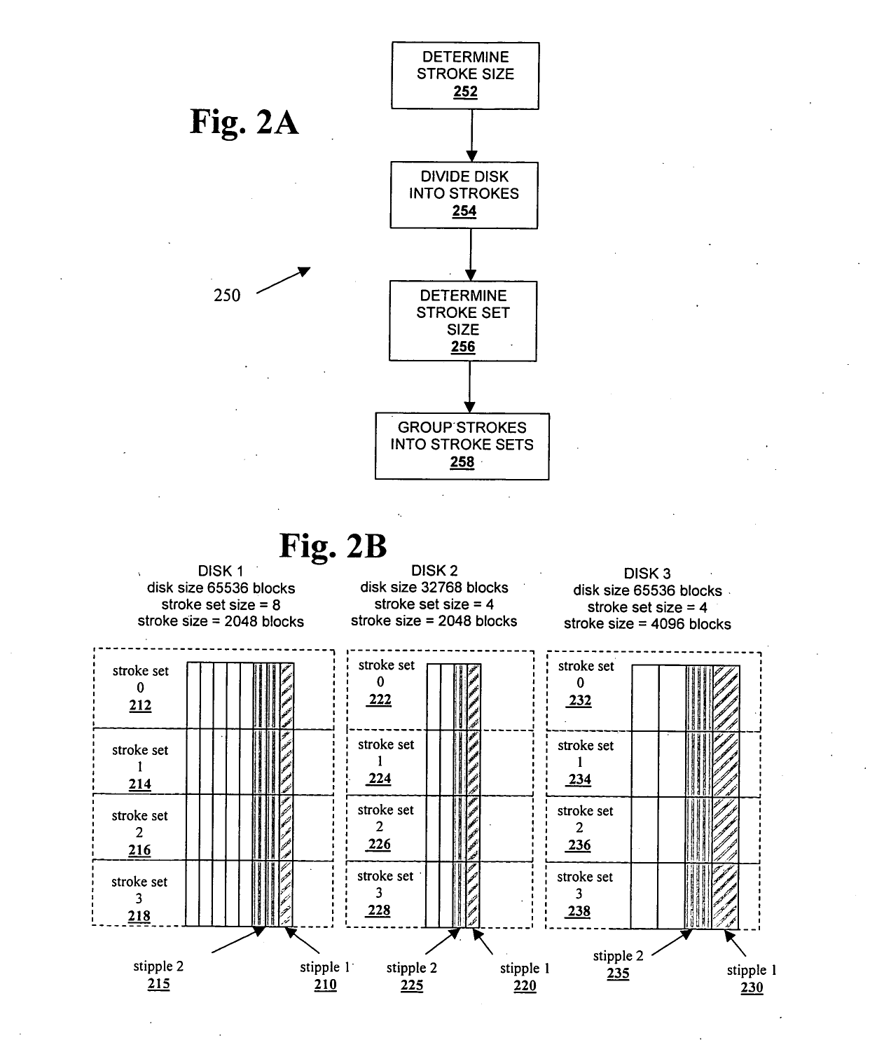

As mentioned above, a stippled disk can be divided into a significant number of small equal size disk portions. These portions can be referred to as “strokes”. Process 250 shown in FIG. 2A further describes the sizing and grouping of strokes. Process action 252 sets the stroke size. In some embodiments, an appropriate size for a stroke is as big as the largest I/O for the disk, but small enough so that there are a significant number (e.g., several thousand) on a disk. For contemporary storage systems an example stroke size is one megabyte. Process action 254 divides the disks into strokes of the determined size. The strokes are grouped into equal fixed-size sets of contiguous strokes which can be referred to as “stroke sets”. The stroke set size is determined in process action 256. The size of the stroke set should be determined such that there is a relatively large number of stroke sets on a disk. In process action 258, the strokes are grouped based on the determined stroke set size. The concatenation of all stroke sets can fill up the entire space, or disk, being stippled.

In some embodiments, the stroke set size of a disk can be changed without remapping existing stipples. This is accomplished by multiplying the stroke set size by an integer and/or evenly dividing the stroke size by an integer. The stipple member set can be changed to add more members to keep the mapping the same. For example, to increase an example stroke set size of 16, multiply by an integer value of 2 to get a stroke set size of 32. Note that the strokes within each stroke set have similar performance characteristics.

In these embodiments, a portion of each stroke set is allocated to each stipple. Therefore, the size of a stroke set can have an effect on the granularity of the stipples. That is, the smaller the stroke set size, the fewer the number of potential stipples; the larger the stroke set size, the larger the number of potential stipples.

Interleaving

FIG. 2B shows an illustrative example of stipples of differing stroke sizes and stroke set sizes. In this particular example, Disk 1 has 65536 blocks, is divided into 32 strokes of 2048 blocks (blocks can also be referred to as sectors) with each block being 512 bytes. The stroke set size of example Disk 1 is 8. Example Disk 1 has 4 stroke sets—stroke set 0, stroke set 1, stroke set 2, and stroke set 3, referenced by element numbers 212, 214, 216, and 218, respectively. Note that these examples are simplified to ease explanation and are not meant to limit scope in any way. One or more strokes from each stroke set can be allocated to each stipple. In this example, stipple 1 uses the first stroke of each stroke set as shown by the four diagonally striped strokes 210. Stipple 2 uses the second and third stroke of each stroke set as shown by the eight vertically striped strokes 215. Notice that the allocating of strokes to stipples in this manner (i.e., interleaving) disperses each stipple throughout the entire stippled space and thus also disperses the disk performance among stipples. Each stipple includes both high and low performing areas of the disk. Note that the strokes do not have to be allocated in order or all at once, that is, there can be unused strokes anywhere in the stroke set to reserve disk space and performance for future use. A stipple can be de-allocated so that the strokes in the stroke set that were being used by the stipple can be reallocated to another stipple.

Note that Disk 2 in FIG. 2B has 32768 blocks, a stroke size of 2048 blocks where the blocks are 512 bytes, a stroke set size of 4 strokes, and includes stroke sets 222, 224, 226, and 228. Stipple 1 (220) uses the first stroke of each stroke set, and stipple 2 (225) uses the second stroke of each stroke set. In this example the potential number of stipples is four, whereas it is eight for Disk 1. However, the stipples are allocated throughout the disk in the same manner. Disk 3 has a stroke size of 4096 blocks and a stroke set size of 4 strokes. Stipple 1 (230) uses the first stroke in each of stroke sets 232, 234, 236, and 238, and stipple 2 (235) uses the second stroke in each of the stroke sets.

Member Numbers

Each stroke in a stroke set can have a member number from 0 to (stroke set size—1). For example, if the stroke set size is 8 strokes, the member numbers can range from 0-7.

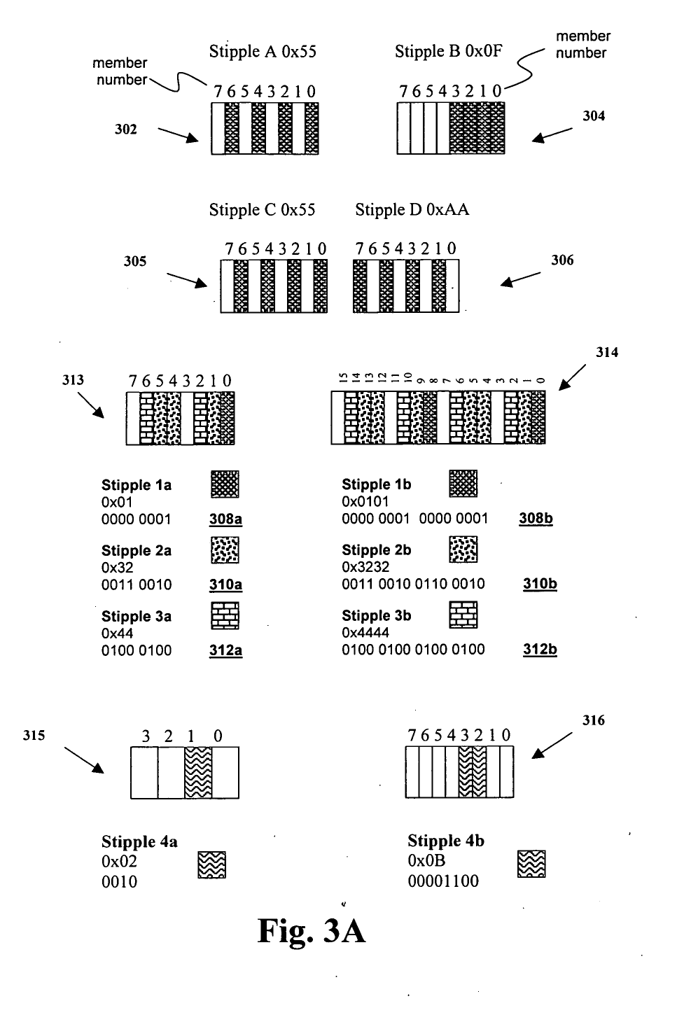

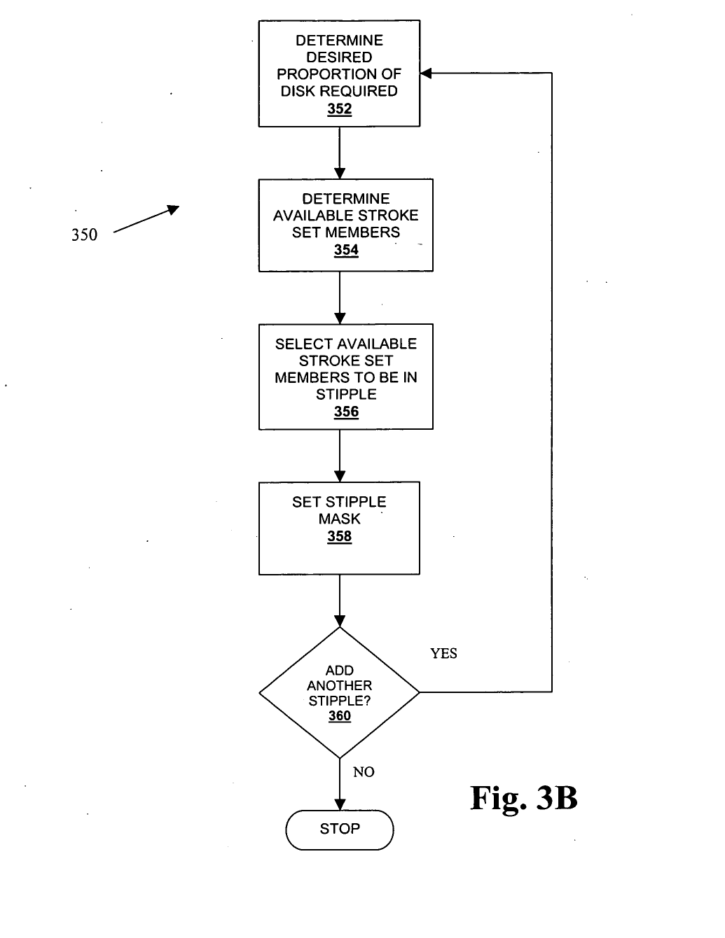

Consider the example shown in FIG. 3A of a disk with a stroke size of one megabyte, and a stroke set size of 8. In some embodiments, each stipple can be defined as a one-byte bit mask where the mask indicates the stroke set members that are part of the stipple. In another embodiment, each stipple can be defined as a member set array where the array members indicate the stroke set members that are part of that stipple. Thus a stroke set 302 with a Stipple A having a bit mask of 0x55 (0101 0101) or a member set array of {0, 2, 4, 6} consists of every other stroke (and in this example every other megabyte) across the whole disk starting at stroke 0. Stipple A consumes half the space of the disk since it contains half of the strokes on the disk. A stroke set 304 with a Stipple B having a bit mask of 0x0F (0000 1111) or a member set array of {0, 1, 2, 3} consists of every other 4 strokes (and in this case, every other 4 megabytes) starting at stroke 0 and also consumes half the size of the disk.

Stipple A and Stipple B can not appear on the same disk since they overlap. However Stipple C with a bit mask of 0x55 (0101 0101) or member set array {0, 2, 4, 6}, and Stipple D with a bit mask of 0xAA (1010 1010) or member set array {1, 3, 5, 7}, shown in stroke sets 305 and 306 respectively, interlace on every other stroke and split the disk in half. Note that it can be more efficient to have the stroke members of a stipple adjacent to each other as in Stipple B.

Another example disk shown in FIG. 3A contains the Stipple 1a (308a) with a bit mask 0x01 (0000 0001) or a member array {0}, Stipple 2a (310a) with a bit mask 0x32 (0011 0010) or a member array {1,4,5}, and Stipple 3a (312a) with a bit mask 0x44 (0100 0100) or member array {2,6}, and still have a quarter of the disk available to allocate as one or 2 new stipples. The three stipples respectively contain ⅛^{th}, ⅜^{th}, and ¼ of the disk.

Recall that, in some embodiments, the stroke set size of a disk can be changed without remapping existing stipples. For example, if the size of stroke set 313 in FIG. 3A is multiplied by the integer 2, the stroke set size doubles from a 1 byte bit mask to a 2 byte bit mask. The existing stipples are not remapped, the existing bit mask is applied to the additional strokes. For example, Stipple 1a becomes Stipple 1b (308b) with bit mask 0x011 and member array {0,8}, Stipple 2a becomes Stipple 2b (310b) with bit mask 0x3232 and member array {1, 4, 5, 9, 12, 13}, and Stipple 3a becomes Stipple 3b (312b) with bit mask 0x4444 or member array {2, 6, 10, 14}. This would allow the remaining quarter of the disk (i.e., stroke set members 3, 7, 11 and 15) to be divided into one to four new stipples.

The stroke size parameter can also be divided evenly by an integer value. This decrease in stroke size causes an increase in the stroke set size. For example, a stroke set 315 has a stroke size of 4096 blocks, a stroke set size of 4, and a stipple 4a using the second stroke of the stroke set. If the stroke size is divided by 2 to make a stroke size of 2048 blocks, the stroke set size is increased to 8 (doubled) so that the stipple ratios in the stroke sets, or stipple proportions, are maintained. The new stipple, Stipple 4b includes the third and fourth strokes of the new stroke set as shown in stroke set 316.

Configuration

Process 350 configures the stipples by assigning stroke set members to each stipple and is illustrated in FIG. 3B. Two stipples on the same disk cannot contain the same member numbers. In process action 352 the desired fraction of the disk that the stipple requires is determined. Process action 354 determines the stroke set members that are available. In one embodiment, the available stroke set members are determined by ORing the masks of the existing stipples and inverting the result. For example, ORing stipple 1 (0x1) and stipple 2 (0xA) is 0xB, when inverted the result is 0x4 as the mask of the available stroke set members. In another embodiment, the available stroke set members are determined by analyzing the member set arrays of the existing stipples. For example, stipple 1 {0} and stipple 2 {1,3} combine to use members {0,1,3}. The remaining available member in the array is {2}. Process action 356 assigns one or more available stroke set members to the stipple. The corresponding bit mask for that stipple is set in process action 358. Process action 360 determines if there are more stipples to define. If yes, process 350 returns to process action 352. If there are no more stipples members to define, the process stops. Stipples do not have to be assigned all at once or in adjacent strokes. Stroke set members can be reserved for future use. A stipple can be de-allocated so that the strokes in the stroke set that were being used by the stipple can be reallocated to another stipple.

Converting the Stipple Block

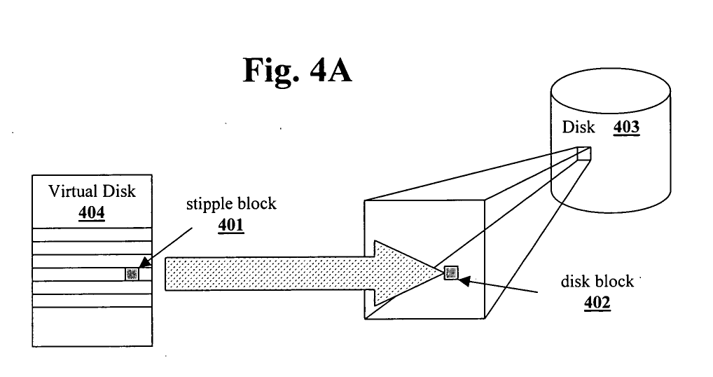

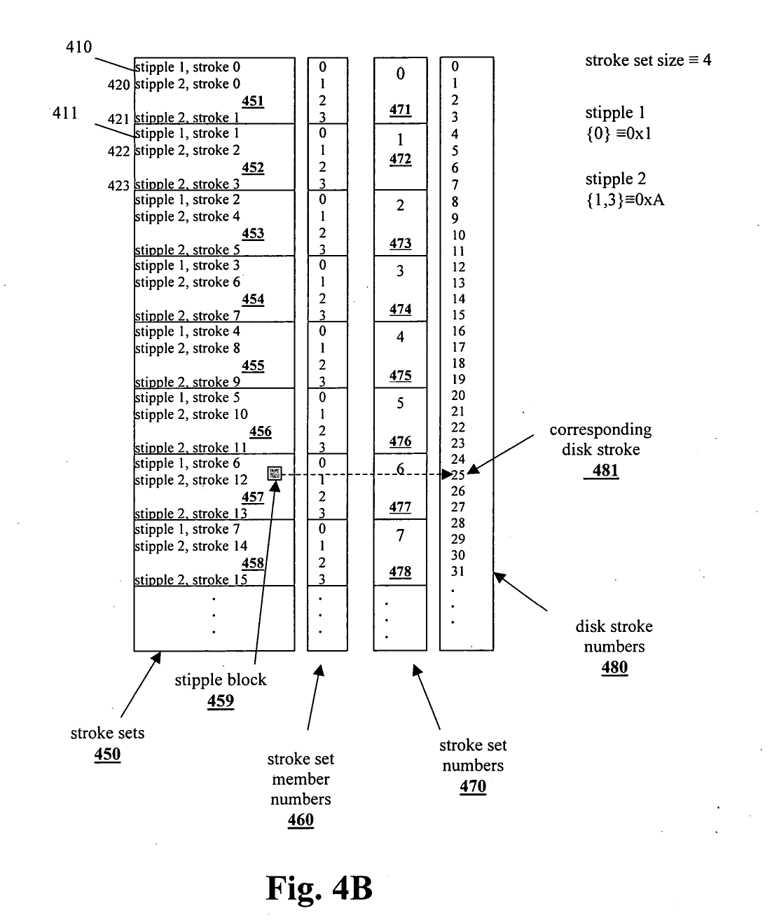

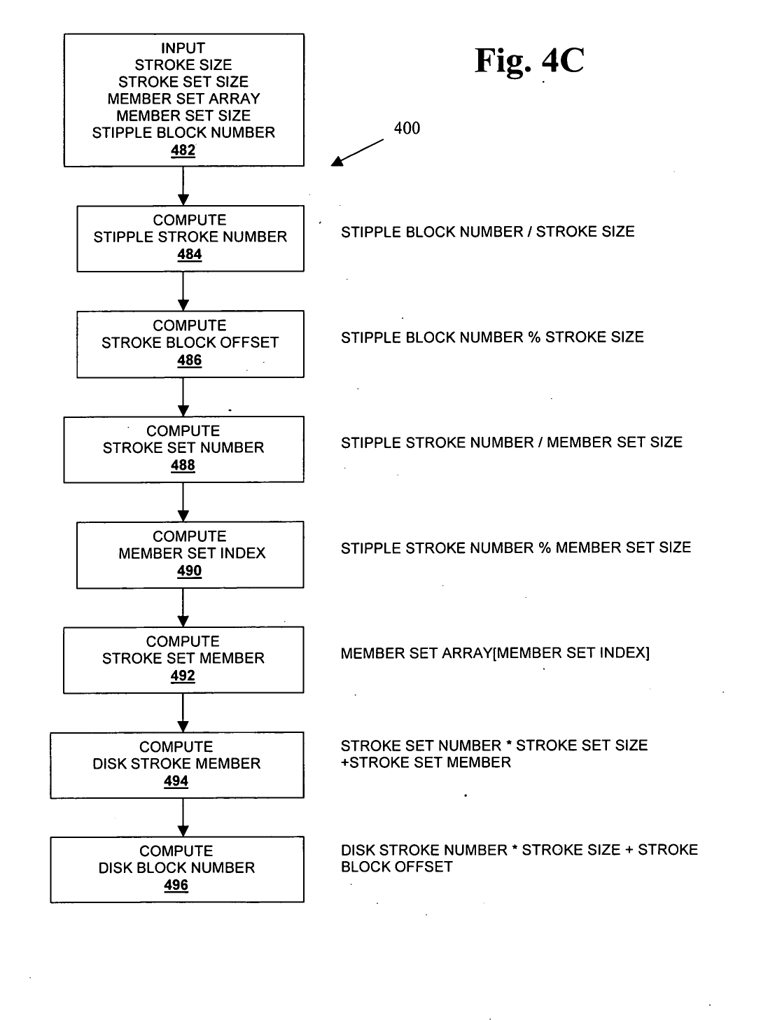

To read the data in a stippled disk, the stipple information can be converted to an actual disk block number to allow seek operations to locate the data. FIG. 4A through 4C are used to illustrate the correlation of a stipple to a disk block and ultimately the conversion of the stipple block number to a disk block number. For example, logical storage 404 in FIG. 4A contains stippled block 401. This stippled block 401 represents a physical disk block 402 in disk 403 on which it resides. The stippled block 401 has a stipple block number that can be converted to a physical disk block number.

For example, to illustrate the concept further, FIG. 4B shows a representation of a set of strokes labeled with disk stroke numbers 480. These strokes are grouped in stroke sets 450 and can be numbered with a stroke set numbers 470. For example, disk strokes 0-31 (480) are shown as grouped into stroke sets 0-7 (471-478). Each stroke set in this example has four members 0-3 as shown in stroke set member numbers 460. For example, stroke set number 0 (471) has stroke set members 0-3, and stroke set number 1 (472) has members 0-3, etc.

The stroke set members are assigned to stipples. In this example, stipple 1 includes all the 0 stroke set member numbers of the stroke sets, represented as member set array {0}. These member set arrays are reflected in the stipple members assigned in the column of stroke sets 450. For example, stroke set member number 0 of stroke set 0 (471) is assigned to stipple 1, stroke set member number 0 of stroke set 1 (472) is assigned to stipple 1, an so on. Stipple 2 includes all the stroke set member numbers 1 and 3 represented as member set array {1,3}. For example, stroke set member numbers 1 and 3 of stroke set 0 (471) are assigned to stipple 2, stroke set member numbers 1 and 3 of stroke set 1 (472) are assigned to stipple 2, and so on.

The strokes in each stipple can be labeled. For example, the first stroke of stipple 1 in stroke set 451 can be labeled stipple 1, stroke 0 (410). The second stroke of stipple 1 in stroke set 452 is labeled stipple 1, stroke 1 (411), and so on from stroke sets 453 to 458. The first, second, third, and forth strokes of stipple 2 can be labeled stipple 2, stroke 0 (420), stipple 2, stroke 1 (421), stipple, 2, stroke 2 (422) and stipple 2, stroke 3 (423), respectively. Note that the first and second strokes of stipple 2 are in stroke set 451, while the third and fourth strokes of stipple 2 are in stroke set 452 and so on from stroke sets 453 to 458.

Each stroke set can be numbered. FIG. 4B shows stroke sets 451-458 are numbered 0-7 in stroke set numbers 471-478 such that, for example, stipple 2, stroke 12 is located in stroke set number 6 (477).

Recall that the unit of measure for stroke size is disk blocks. Each of the virtual stipple blocks such as 401 in FIG. 4A corresponds to a disk block such as 402 in FIG. 4A. When a seek is performed on a stippled disk, the actual physical disk block number is required to find the required data. As each stipple's virtual blocks are numbered starting with 0, a conversion process is needed to facilitate determining the disk block number from a stipple block number. In some embodiments, arithmetic equations can be used to convert the stipple block number into a disk block number. This embodiment is shown in process 400 of FIG. 4C.

To convert a Stipple Block Number into a Disk Block Number using arithmetic equations the member set of the stipple is represented as an array of indexes rather than as a bit mask. For example, if there are 8 strokes in a stroke set then the Stroke Set Size is 8. The Member Set Array for the example mask 0x32 (0011 0010) is {1, 4, 5}. The Member Set Size in this example is 3 since there are 3 strokes of the stroke set that are part of this stipple. The Stroke Size in this example is 2048 blocks. These variables are defined in process action 482 of FIG. 4C. The following process actions in FIG. 4C execute the following equations to convert the Stipple Block Number into a Disk Block Number.

| Process | |
|---|---|
| Action | Calculation |
| 484 | Stipple Stroke Number = Stipple Block Number/Stroke Size |
| 486 | Stroke Block Offset = Stipple Block Number % Stroke Size |
| 488 | Stroke Set Number = Stipple Stroke Number/Member Set Size |
| 490 | Member Set Index = Stipple Stroke Number % Member Set Size |
| 492 | Stroke Set Member = Member Set Array [Member Set Index] |
| 494 | Disk Stroke Number = Stroke Set Number * Stroke Set Size + |
| | Stroke Set Member |
| 496 | Disk Block Number = Disk Stroke Number * Stroke Size + |
| | Stroke Block Offset |

In process action 484 the Stipple Stroke Number is calculated by dividing the Stipple Block Number by the Stroke Size, with the Stroke Size having units in blocks. In Process action 486 the Stroke Block Offset is obtained by calculating the remainder of the quotient of the Stipple Block Number and the Strike Size in units of blocks. The “%” sign indicates the mathematical operator of modulo which calculates the remainder. Process action 488 calculates the Stroke Set Number using the calculated Stipple Stroke Number divided by the Member Set Size determined in process action 482. In process action 490 Member Set Index is calculated as the remainder of stipple Stroke Number divided by the Member Set Size. Process action 492 calculates Stroke Set Member. Stroke Set Member is the stroke set member number of the member, the Member Set Index is a positional number referring to the first (0), second (1), third (2), etcetera member or each stroke set. For example, if the Member Set Array is {0, 2, 4, 6}, then a Member Set Index of 3 points to the fourth stroke set member number starting from the lowest member. In this example, the fourth stroke set member number is 6. Process action 494 uses the Stroke Set Member calculated in process action 492 to calculate Disk Stroke Number. Process action 496 uses the Disk Stroke Number to calculates Disk Block Number.

The following two example illustrate conversion of a stipple block into a disk block.

### EXAMPLE 1

Example 1 shows how Stipple block 1,000,000 of the above example stipple would be mopped to a disk block. In process action 482 the inputs are set as follows.

Stroke Size is 2048 blocks—one megabyte of 512 byte sectors.

Stroke Set Size is 8 strokes—the disk is divided into stroke sets of 8 strokes each.

Member Set Size is 3—this stipple uses 3 strokes of each stroke set—⅜^{th} of the disk.

Member Set Mask is 0x32—this identifies which strokes are used in each stroke set.

Member Set Array is {1, 4, 5}—a different representation of the information in the mask.

Stipple Block Number is 1,000,000—the stipple block to be mapped to a disk block.

The following chart details the process action in process 400, and the calculation performed at that process action for this example.

| Process Action | Calculation |
|---|---|
| 484 | Stipple Stroke Number = 1000000/2048 = 488 |
| 486 | Stroke Block Offset = 1000000 % 2048 = 576 |
| 488 | Stroke Set Number = 488/3 = 162 |
| 490 | Member Set Index = 488 % 3 = 2 |
| 492 | Stroke Set Member = Member Set Array [2] = 5 |
| 494 | Disk Stroke Number = 162 * 8 + 5 = 1301 |
| 496 | Disk Block Number = 1301 * 2048 + 576 = 2665024 |

From these calculations, block 1,000,000 of the stipple maps to block 2,665,024 on the disk. Since the stipple consumes ⅜^{th} of the disk it makes sense that the disk block number is close to 8/3^{rd} times as large as the stipple block number.

### EXAMPLE 2

Example 2 shows how block number 25000 in stipple number 2, illustrated by element 459 in FIG. 4B, is mapped to a disk block. In process action 482 the inputs are set as follows.

Stroke Size is 2048 blocks—one megabyte of 512 byte sectors.

Stroke Set Size is 4 strokes—the disk is divided into stroke sets of 4 strokes each.

Member Set Size is 2—stipple 2 uses 2 strokes of each stroke set—½ of the disk.

Member Set Mask is 0x5—this identifies which strokes are used in each stroke set.

Member Set Array is {1, 3}—a different representation of the information in the mask.

Stipple Block Number is 25,000—the stipple block to be mapped to a disk block.

The following chart details the process action in process 400, and the calculation performed at that process action for this example.

| Process Action | Calculation |
|---|---|
| 484 | Stipple Stroke Number = 25000/2048 = 12 |
| 486 | Stroke Block Offset = 25000 % 2048 = 424 |
| 488 | Stroke Set Number = 12/2 = 6 |
| 490 | Member Set Index = 12 % 2 = 0 |
| 492 | Stroke Set Member = Member Set Array [0] = 1 |
| 494 | Disk Stroke Number = 6 * 4 + 1 = 25 |
| 496 | Disk Block Number = 25 * 2048 + 424 = 51,624 |

From these calculations, block number 25000 of stipple number 2 maps to disk block 51,624. Note that process action 494 calculates that the stipple 2 block 25000 corresponds to a Disk Stroke Number of 25 (481). Since the stipple consumes ½ of the disk it makes sense that the disk block number is close to 2 times as large as the stipple block number.

Stippling and Partitions

Stipples can be mirrored by stipples on other disks. A disk may be both stippled and partitioned. Either a stipple can be partitioned (most likely by a host), or a partition can be stippled. Stippling provides a method of dividing a disk into portions that can be treated like virtual whole disks. This new methodology can be useful for a storage array that is presenting portions of a disk as a virtual disk to different hosts.

Stippling and Performance

Stippling results in the set of allocated spaces (e.g., virtual disks) being evenly spread across the storage area, or disk. The host that uses the virtual disk can assume that the lower block numbers are closer to the outer rim of the disk and thus perform better. This is helpful for maximizing the utilization of large disks. A small heavily used file system can be placed on the first partition of the virtual disk and a second larger file system can be placed on the remainder of the virtual disk to hold old infrequently accessed data. This can be done without knowing the physical location of the partition underlying the virtual disk and without giving the host an entire physical disk.

For example, with RAID 5 a single address space is constructed from multiple physical spindles. The RAID 5 space can be divided into stipples as if it is one single disk. In one embodiment, the stroke size can be aligned with a multiple of the RAID 5 stripe size. When stippling a RAID 5 disk it makes sense to align the stroke size with the RAID 5 stripes so that each stroke contains an integral number of stripes.

Stippling can provide more efficient use of a disk for a system with multiple hosts that cannot coordinate disk allocation with each other. The lower disk addresses of all the virtual disks are on the outer edge of the physical disk. As the hosts start filling up their virtual disks with data, all the data from all the hosts is on the outer edge of the disk. Stippling can be configured such that there are no gaps of unused space between each virtual disk.

Stippling can make it easier to manage performance since all the stipples have similar performance. An unused stipple preserves not only its space on the disk, but also a portion of the disk's performance. An unused stipple contains some blocks of every performance characteristic available on the disk.

Stippled Disks and ASM

Disk stippling can work with the Automated Storage Management (ASM) product which is commercially available from Oracle Corporation of Redwood Shores, Calif. More information regarding implementation of ASM can be found in U.S. Pat. No. 6,530,035 and U.S. Pat. No. 6,405,284 which are hereby incorporated by reference as if fully set forth herein. The stroke size can be set to match the ASM allocation unit size and the two can be aligned. Each allocation unit can be one stroke on the underlying physical disk. This can keep one megabyte aligned I/O's on contiguous storage all the way from the file I/O down to the physical disk I/O.

Stippling can also be applied to support ASM sharing disks between hosts with different operating systems. If the storage array can present virtual disks that are stipples, then disk groups on different hosts can efficiently share the same disks.

For example, allocating two partitions on the same disk to the same disk group in a system without stippling is inefficient, resulting in the system trying to load balance between two areas on the same disk and causing many useless seeks. On the other hand, allocating two stipples on the same disk to the same disk group has only minor consequences, resulting in some extents being relocated to the new stipple. But these extents will go to the outer edge of the physical disk along side of the existing data in the other stipple.

I claim:

1. A method of managing disk space and performance, comprising:
determining a set of parameters; and
configuring one or more stipples, each stipple being one of a set of interleaved portions distributed evenly throughout a disk space.

2. The method of claim 1, wherein each stipple has similar performance characteristics.

3. The method of claim 1 wherein configuring the stipple utilizes the set of parameters, the set of parameters including a number of blocks in a stroke, and a number of strokes in a stroke set, and wherein configuring comprises:
determining which strokes in the stroke set are available; and
selecting one or more available strokes for the stipple.

4. The method of claim 4, wherein configuring the stipple further comprises:
determining a fraction of disk space required; and
selecting one or more available strokes based on the fraction of disk space required.

5. The method of claim 1 wherein the stipples can be partitioned.

6. The method of claim 1, wherein stipples can be configured in any virtual disk space.

7. The method of claim 1, further comprising converting a stipple block number to a disk block number using arithmetic equations.

8. The method of claim 7 wherein the converting comprises:
determining a stroke size, a stroke set size, a member set array, and a member set size;
computing a stipple stroke number as an integer quotient of the stipple block number and the stroke size;
computing a stipple stroke offset as a remainder of the stipple block number divided by the stroke size;
computing a stroke set number as an integer quotient of the stipple stroke number and the member set size;
computing a member set index as a remainder of the stipple stroke number divided by the member set size;
computing a stroke set member as the member set array;
computing a disk stroke member as a sum of the stroke set member and an arithmetic product of the stroke set number and the stroke set size; and
computing the disk block number as a sum of the stroke block offset and the arithmetic product of the disk stroke number and the stroke size.

9. A system of managing disk space and performance, comprising:
logic for determining a set of parameters; and
logic for configuring one or more stipples, each stipple being one of a set of interleaved portions distributed evenly throughout a disk space.

10. The system of claim 9, wherein each stipple has similar performance characteristics.

11. The system of claim 9 wherein the logic for configuring the stipple utilizes the set of parameters, the set of parameters including a number of blocks in a stroke, and a number of strokes in a stroke set, and wherein the logic for configuring comprises:
logic for determining which strokes in the stroke set are available; and
logic for selecting one or more available strokes for the stipple.

12. The system of claim 9, further comprising logic for converting a stipple block number to a disk block number using arithmetic equations.

13. A computer program product embodied on computer readable medium, the computer readable medium having stored thereon a sequence of instructions which, when executed by a processor, causes the processor to execute a method for managing disk space and performance, the method comprising:
determining a set of parameters; and
configuring one or more stipples, each stipple being one of a set of interleaved portions distributed evenly throughout a disk space.

14. The computer program of claim 13, wherein each stipple has similar performance characteristics.

15. The computer program of claim 13 wherein configuring the stipple utilizes the set of parameters, the set of parameters including a number of blocks in a stroke, and a number of strokes in a stroke set, and wherein configuring comprises:
determining which strokes in the stroke set are available; and
selecting one or more available strokes for the stipple.

16. The computer program of claim 13, further comprising converting a stipple block number to a disk block number using arithmetic equations.

17. A method of distributing a disk space comprising:
dividing a disk space into equal portions;
grouping the portions into sets, each set comprised of an equal number of portions;
assigning one or more of the portions in each set to a stipple.

18. The method of claim 17 wherein each portion in a set has similar performance characteristics.

19. The method of claim 17, wherein each stipple has similar performance characteristics.

20. The method of claim 17, further comprising converting a stipple block number to a disk block number using mathematical equations.

21. A system of distributing a disk space comprising:
logic for dividing a disk space into equal portions;
logic for grouping the portions into sets, each set comprised of an equal number of portions;
logic for assigning one or more of the portions in each set to a stipple.

22. The system of claim 21, wherein each stipple has similar performance characteristics.

23. A computer program product embodied on computer readable medium, the computer readable medium having stored thereon a sequence of instructions which, when executed by a processor, causes the processor to execute a method for distributing a disk space, the method comprising:
dividing a disk space into equal portions;
grouping the portions into sets, each set comprised of an equal number of portions;
assigning one or more of the portions in each set to a stipple.

24. The computer program of claim 23, wherein each stipple has similar performance characteristics.

25. A method of managing disk space allocation, comprising
distributing a set of stipples evenly throughout a disk space, the stipples in the set being interleaved.

26. The method of claim 25, wherein each stipple has similar performance characteristics.

27. A method of managing disk space and performance, comprising:
distributing a disk into a plurality of portions, each portion having similar performance characteristics.
